(19) United States
(12) Patent Application Publication
(10) Pub. No.: US 2005/0151846 A1
(43) Pub. Date: Jul. 14, 2005

(54) Traffic surveillance method and system

(76) Inventor: William Thornhill, Falls Church, VA (US)

Correspondence Address: J. John Shimazaki;Patent Office, P.O. Box 650741, Sterling, VA, 20165, US

(21) Appl. No.: 10/756,852

(22) Filed: Jan. 14, 2004

(51) Int. Cl. H04N 7/18

(52) U.S. Cl. 348/149; 348/143

(57) ABSTRACT

The invention relates generally to a method and system for monitoring traffic events at a predetermined location, using a temporary video camera set up to record traffic movements through an intersection or other location along a road. The method preferably comprises taking a video recording of the location, and then sending the recording to a foreign country where the recording can be reviewed manually at a reduced cost. To facilitate an accurate and consistent review of the recording, the invention preferably uses “event lines” that can be superimposed on the video monitor, wherein the event lines help determine when a vehicle has passed through an intersection, i.e., when a recordable traffic event occurs. The system also preferably uses a computer-operated program adapted to assist the operator in reviewing, verifying and summarizing the recorded information, wherein a particular key or keys can be pressed depending on the type of event to be indicated. The system is also able to identify the exact frame number of a recordable event that corresponds to an exact moment in real time, i.e., when the event actually occurred. A tripod-like apparatus for temporarily setting up a video camera in locations where no existing pole or structure is available, as well as a tamper-proof housing in which the video recording device can be temporarily mounted, can also be provided.

### FIELD OF THE INVENTION

The present invention relates to traffic surveillance methods and systems, and in particular, to a system used to accurately record, measure and verify recordable traffic events that occur at a predetermined location.

### BACKGROUND OF THE INVENTION

Developers, land use planners, city and local governments, etc., often use traffic and transportation planning studies to determine traffic patterns for a particular location, in support of decision-making with respect to land use, or the development and management of transportation infrastructure. Such studies are beneficial because they often provide helpful information regarding existing traffic conditions and patterns, which can be used for planning and development purposes, to help ensure that traffic problems can be limited or avoided in the future. Based on these traffic studies, for example, modifications can be made to roads and walkways, including adding new roads, widening existing roads, and creating pedestrian walkways, etc. Other improvements, such as creating or increasing the size and number of public recreation areas, parks, open spaces, etc., to account for increased traffic generated by the new development, can also be provided.

Of particular interest is the number of motor vehicles that may pass through a particular intersection or point in a roadway in an area close to the proposed project. For this purpose, a traffic count commonly called a “turning movement count” (in the case of an intersection) or “classification count” (in the case of a mid-block location on a roadway) is often used to determine traffic conditions and patterns at a location of interest. In the case of turning movement counts, this type of count generally determines not only the total number of vehicles that pass through an intersection over a predetermined period of time, but also how many of them turn right, turn left, or go straight, etc. Turning movement counts are usually conducted during two-hour or three-hour periods that span the site's peak hours. Usually there is one such period in the morning and another in the afternoon, and in some areas, additional counts can be made during the lunchtime peak, and for shopping areas, during the Saturday afternoon peak. Classification counts are typically made over a longer period, which can be as long as a full week, but may be for 24 hours or for shorter periods, that attempt to capture traffic during the most active hours, such as 6 a.m. to 9 p.m.

The most important output of this type of count is a table and diagram summarizing several types of traffic patterns and flows during fixed periods of time, usually comprising 15 to 60 minute intervals during which traffic flow is greatest. This information is then used as input to create one or more mathematical models that help analyze the performance of the roadway under existing and future traffic conditions.

Traditionally, intersection turning movement counts have been performed manually by sending human counters into the field to observe and record actual traffic events in real time, and then afterwards processing the raw field data to develop various kinds of summary statistics. Such manual counts have often involved the use of pencil and paper, which can be supplemented by finger-operated mechanical counters. In an intersection with light traffic flow, a single person might be able to conduct the traffic count, but in a large, high-volume intersection, several people may be required, each responsible for specific areas, i.e., one person may be needed to count all southbound traffic, another for all northbound traffic, another for all turns, etc. Another may be needed to count the types of vehicles that pass through.

In many cases, the survey supervisor creates a pre-printed form for each counter, wherein each form has spaces on which to write down the location of the intersection, the overall counting period, the particular approach or approaches used for counting, and sometimes, the weather and pavement conditions. In such case, each counter may count the number of vehicles that pass through the intersection during five-minute intervals, and then record the numbers on pre-printed forms. If a finger-operated mechanical counter is used, the display can be cleared to zero at the end of each 5-minute period, and counting can resume starting at zero.

These manual counts are often supervised by junior-level engineers or technicians who are responsible for supervising several counts simultaneously. What usually happens, therefore, is that the supervisor will meet the counters at the intersection at a pre-arranged time, hand out clips or counting boards, and then leave in order to set up another intersection count. At the end of the counting period, the supervisor may come back and collect the counting materials. Then, at some point during the succeeding days, the supervisor may assemble the field forms and transfer information to a paper form or computer spreadsheet, and then add up the subtotals and totals, calculate a few simple ratios, and then produce a turning movement diagram.

Another common technique is the use of electronic counting boards. This type of board typically comprises a small computer that has buttons corresponding to each turning movement, i.e., either 12 or 16 depending on whether U-turns are recorded separately from left turns. In use, the counter hits one of these keys every time a vehicle passes, and the board saves the event that has been selected in memory. At the end of the counting period, the survey supervisor collects the boards, goes back to the office, and downloads the data into a pre-programmed database, which then prints all the required summary information.

The above methods suffer from the same three basic limitations, as follows:

Mislabeling. At the end of the fieldwork, the engineer is left with a pile of paper forms, or a stack of counting boards, all containing collections of numbers. Very often, the labeling of the forms and boards is incomplete or inaccurate. For example, a count of southbound traffic may be mislabeled northbound, the intersection location may be mislabeled, or the counts of morning traffic may be mistaken for counts of afternoon traffic, etc.

Measurement Error. An equally serious limitation is the potential for human error made by the counter. Because the counts are performed in real time, there is no way to slow down the counting or correct any errors. If several vehicles enter the intersection at the same time, for example, the counter may not be able to keep up. Moreover, the counter may get confused and end up hitting the wrong button, or make a mark in the wrong box. Sometimes a vehicle may be counted as having passed through, but in actuality, it may have stopped further into the intersection, and the counter could easily forget to correct the count, and end up counting it again when the car starts moving again. Also, because counting personnel are not usually directly supervised during most of the survey period, they may take unauthorized breaks, and/or fill in forms with invented numbers.

Lack of Credibility. Most traffic data is highly suspect by end users, and with good reason. There are frequent and significant errors because of the two inherent limitations described above. Further, because conclusions of traffic studies are largely dependent on data, many who review traffic studies believe (often justifiably) that the underlying traffic counts are not accurate or were forged in some way. If the counts are conducted in real time and cannot be replicated, there is no way for users of the data to prove or disprove the outcome of a particular count.

While the electronic boards make it somewhat easier to count vehicles and also facilitate data processing, they do not solve the basic problem of real-time counts. Counters can still make mistakes, and there is no way to correct them or verify the results.

Another method used in the industry is the use of video recordings. Videotape has been used for various types of traffic surveys for over 20 years. The methodology is really a hybrid of video recording and manual counting. Instead of sending a group of people into the field to count traffic in real time, a single person or small team will go out to make a videotape of the location, and then the videotape is brought back to an indoor setting where the tape is replayed, and where counts can be conducted using the manual techniques described above.

This methodology overcomes some of the main limitations of manual methods. First, the location and identity of the counting site is less likely to be mistaken because a visual image of the site is recorded. If there is any doubt, the site could always be revisited to verify that it matches the site on the video. The same is true for the direction of traffic flow.

Second, it allows the counter to reduce the playback speed during periods of high traffic flow, or pause the playback, such as for work breaks, and to repeat portions of the tape, if necessary, so that the counter can verify the data was correctly recorded.

Finally, and perhaps most importantly, the video can be played back for anyone who questions the validity of the summary statistics.

The main problem with past video recording methods, however, is that they are extremely labor intensive and therefore costly. For instance, it can take ten or more man-hours to count only two hours of traffic, not including the time required to set up and tape record the recordings. Because traffic counts are a relatively low-budget item, video recordings have thus far only been economically feasible for specialized research studies.

Another problem is the difficulty of obtaining clearly observable videos. In many cases, it is more difficult to identify individual vehicles on videotape than it is from direct observation. For example, large trucks and buses can block the observer's view. One previous solution to this problem was to elevate the video camera high enough so that it can look down onto the intersection, over the top of passing trucks and buses. Elevation may not always be required at small intersections, but for large intersections that have 4 to 6 lanes, or divided roads, a camera height of 20 to 35 feet is often required to view the entire intersection properly, i.e., see over the top of trucks and buses. If the survey is done in an urban area, and there is a building on the corner at least about 3 stories tall, and permission from the building owner can be obtained, then the video camera can be mounted on the building. Otherwise, the surveyor has to erect a structure of some kind to hold the video camera.

There are also several technologies available for automatically detecting vehicle flows when traffic is moving, such as in a straight line. These include pneumatic tube counters, electrical and electronic counters using induction loops as sensors, and machine-vision video detection systems. These systems, however, are not yet very reliable in terms of being able to accurately record the various movements that a vehicle can make through an intersection, including turns. They are also not good at accurately recording the type of vehicle that passes through, and other aspects, like pedestrian counts, etc.

### SUMMARY OF THE INVENTION

The present invention relates generally to a system for monitoring traffic events at a predetermined location, using a temporary video recording system set up to record traffic movements through an intersection. There are several features of the invention that are the subject of this application, as follows:

First, the invention preferably comprises a method wherein video recordings are recorded on video tape or a hard disk at a predetermined location, such as an intersection, and wherein the recording is reviewed manually to count the number of traffic events that occur at that location, but unlike previous methods, the present invention contemplates reviewing the recordings in a remote location, by a counter in a foreign country, where labor is relatively inexpensive. That is, although the recording of the video can take place on location in real time, much like in past systems, the recording is preferably sent to a remote location where it can be reviewed carefully and methodically, by technicians and operators that can work at a reduced cost, relative to the country where the recordings are made. This enables additional time to be spent reviewing, counting and summarizing the information, and making sure the information and data are accurately recorded. And, because of the lower labor costs involved, there will be less pressure on counters to work faster, wherein the counters will be more likely to stop the recording when necessary, and/or re-review the recording to make sure the count is correct, which can help overcome the deficiencies of past systems. In the preferred embodiment, two individual counters are used to review each recording, wherein the results of the counting can then be analyzed and compared by a supervisor to better ensure accuracy of the count.

Also, the recording is preferably converted into digital format and stored as a file on a hard disk and copied onto an efficient permanent medium, such as a DVD, so that the file can then be transmitted from the origin country to the destination country by express courier or by electronic data transfer, and copied onto a computer or other server in the foreign country to make it easier for the operator to review and count the recordings. In this respect, the method preferably comprises using an office in the foreign country equipped with the appropriate computer systems and programs to review and study the video recordings. Personnel are also preferably trained to help ensure that they will know what to look for when reviewing and studying the recordings.

Second, to facilitate an accurate review of the recordings in the remote location, the invention preferably contemplates using “event lines” that can be superimposed on the video image, either physically on the screen, or digitally within the computer software, while reviewing the recordings. An event line is a line extending across each lane of traffic in the predetermined direction of traffic. The use of event lines can assist the operator in accurately determining when a vehicle has passed through an intersection, i.e., a recordable event occurs any time a vehicle crosses any one of the event lines in the direction of traffic. When a vehicle enters the intersection, for example, but does not cross the event line, no recordable event occurs, and therefore, the counter will know not to count that event. At the same time, whenever a vehicle does cross the event line, the counter is trained to record the event, and therefore, even if the vehicle stops later in the intersection, as long as it does not cross the event line again, the counter will not count that event twice.

When a four-way intersection is monitored, four event lines are preferably provided, i.e., one in each direction of traffic, across the lanes of travel. In such case, each event line preferably has three sections: the left section is angled to indicate when a vehicle turns left, the right section is angled to indicate when a vehicle turns right, and the middle section is perpendicular to the direction of travel to indicate when a vehicle travels straight through. Each event line is also preferably extended well into the intersection, so that vehicles that stop short, or turn around before actually going through, are not counted (because they won't cross an event line). This removes the guesswork that might otherwise be involved in determining what constitutes a recordable traffic event. This also reduces the need for supervision, since counters will clearly know when to count an event, and when not to count an event, as well as the chances of making an error. This also makes it possible to accurately record the precise moment in time when the recordable traffic event occurred in real time, since the moment the vehicle crosses an event line is a specific definable time, i.e., as opposed to the length of time it takes a vehicle to pass through the entire intersection.

Third, the system preferably uses a computer-operated program adapted to assist the operator in reviewing, verifying and summarizing the recorded information. In addition to a computer that enables the recording to be reviewed quickly, the present invention contemplates using a software program that provides a way for the counters to indicate the type of recordable event that has occurred and when it has occurred. For example, the program preferably has means to allow the operator to press a particular key or keys on the keyboard, which correspond(s) to the type of event that has occurred, so that while reviewing the images, the counter can press the appropriate key or keys, and, based on what event he or she has observed, indicate what type of event it was. For example, the counter can press one key for a left turn, another key for a right turn, another for a vehicle passing straight through, another to indicate that a pedestrian has walked through, another to indicate the type of car that passed through, such as a sedan, truck, van, etc. This way, the type of event that is indicated is simultaneously recorded as a record in a database stored on the computer's hard disk. This allows the computer to keep track of each recorded event, at the same time the counter makes the indication, so that the type of event that has been recorded is stored for later retrieval and analysis. Different signals are also preferably used to “announce” to the counter whether the correct indication was made.

Fourth, in some cases, it is important for the counter to be able to identify the exact frame number of a recordable event on the recording that corresponds to an exact moment in real time, i.e., when the event actually occurred. But because the counter presses keys while reviewing the recordings typically days, if not weeks, after the recordings are made, there is always a difference between the actual clock time recorded on the recording, and the time the counter counts them as recordable events (and selects the frame number to record in the database). Furthermore, although standard video images display the actual clock time when recordings are made, there is usually a variance in the frame rate per second from one section of the recording to another. Accordingly, a synchronization feature is preferably contemplated by the present invention to make it possible to identify the exact frame number that corresponds to an exact moment in real time when the recordable event occurred, such as to within 1/30^{th} of a second.

The synchronization works as follows: When recordings are made using conventional recording equipment, the actual clock time is often displayed and broken down by the hour, minute and second, which, for purposes of this discussion, will be referred to as the “screen time.” Even though NTSC videos typically have a nominal frame rate of close to 29.97 frames per second, in actual practice, this frame rate varies slightly from one section of the recording to another. Therefore, the time of the event, and the frame number that the event is recorded on, are not always synchronized accurately throughout the entire recording. Accordingly, using conventional equipment, it would not always be possible to identify the exact frame number corresponding to an exact screen time, i.e., within 1/30^{th} of a second.

The present invention contemplates using a program that allows the time that the recordable event actually occurred to be synchronized with the frame number associated therewith. This can be accomplished by using a calibration process that involves the counter stepping through the video and entering the exact screen time shown at predetermined intervals, such as every 10 minutes, so that the frame number of the frame currently being displayed can be converted to the equivalent screen time, and vice versa. This way, not only is a record made and written to the database with fields for the vehicle and event type, as discussed above, but the record also contains the specific time measured to the hundredth of a second, and a very specific frame number associated with the actual precise event time. This time synchronization feature gives the system the ability to associate each observed event (identified by frame number) with the actual time that it occurred. It also allows the frame number to be retrieved by knowing the event time, and the event time to be retrieved by knowing the frame number.

Fifth, another aspect contemplated by the present invention comprises a tripod-like apparatus for temporarily setting up a video camera in locations where no existing pole or structure is available. The apparatus preferably comprises a pole that can be extended up (such as telescopically) to support the video camera above ground, and means for securing the pole in a fixed position. Because it is important that the pole remain fixed, and not sway or move, the apparatus preferably comprises three legs and three support arms extending outward from the pole that are attached to three concrete blocks that weigh the structure down. The level of each leg can preferably be adjusted, relative to the concrete blocks, by virtue of a threaded member extending between each block and leg arm, wherein by adjusting each threaded member, the angle of the support pole can be adjusted and maintained regardless of the slope of the ground.

This apparatus preferably enables the video camera to be set up quickly and economically at virtually any location, regardless of whether there is a building or pole on which to mount the camera already in existence, and regardless of the size of the intersection. This gives the traffic surveillance team more flexibility in setting up the video camera in locations that are optimum for viewing accuracy and clarity, thereby helping to ensure better data. The height of the camera can also be adjusted depending on the type of vehicles that are expected to pass.

Sixth, where there is an existing pole available on which to mount the video camera, the invention also contemplates a tamper-proof housing in which the video recording devices can be temporarily mounted, and a tamper-proof bracket to attach the housing to an existing pole, wherein the housing and its bracket can only be removed from the pole by someone having access to within the interior of the housing which is behind a locked door. This way, the door would have to be opened in order for the housing to be removed from the bracket, and the housing must be removed from the bracket to gain access to the connectors that attach the bracket to the pole, thereby making it more difficult for vandals to remove the housing and steal the video equipment. The only way that a vandal could steal the video equipment would be by breaking through the locked door, and then removing the housing from the bracket.

### BRIEF DESCRIPTION OF THE DRAWINGS

FIG. 1 shows a tripod-like support for temporarily positioning a video recording system at an intersection or roadway high above the ground in a fixed and stable manner;

FIG. 2 shows a video camera head that may be attached to the tripod-like device shown in FIG. 1 or attached to an existing pole using a mounting bracket. The video camera head preferably consists of a CCTV security-type video camera mounted within a weatherproof camera housing that may include a heater and a fan, and a motorized or manually operated pan/tilt device that allows for the camera to be aimed horizontally and vertically;

FIG. 3 shows a tamper-resistant housing for temporarily storing video recording equipment that can be quickly mounted onto or dismounted from an existing pole or to the vertical shaft of the tripod-like device shown in FIG. 1;

FIG. 4 shows a bracket for mounting the equipment housing of FIG. 3 to an existing utility or other vertical pole;

FIG. 5 shows a four-leg intersection with conventional stop lines;

FIG. 6 shows a four leg intersection with a multi-segment event line superimposed in each of the four directions of travel; and

FIGS. 7 to 11 represent flow charts showing the present method implemented as a business model in a hypothetical case where the foreign country is Mexico.

### DETAILED DESCRIPTION OF THE INVENTION

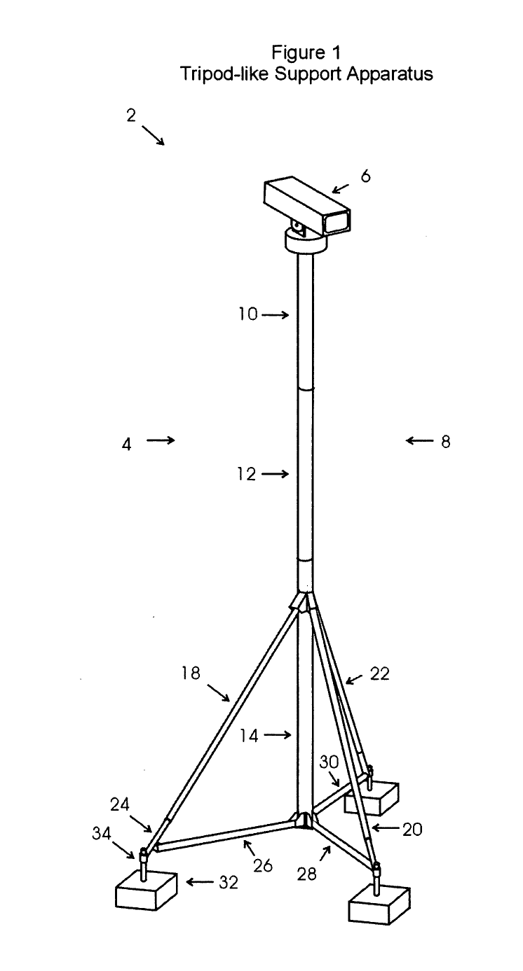

FIG. 1 shows a support apparatus 2 that can be used in conjunction with the method of the present invention. The support apparatus 2 preferably comprises a tripod-like structure 4 for temporarily setting up a video camera head 6 above ground in locations where no existing pole or structure is available. This apparatus 2 can be used in situations where there are no means of positioning the video camera head 6 at the appropriate level above ground. It helps to maintain the video camera head 6 in a substantially fixed and stable position.

The apparatus preferably comprises a pole 8 that can be extended up to support the video camera head 6 above ground, i.e., it can be made in two or more sections 10, 12, 14 that fit telescopically or which can be joined together using a bayonet style coupling or other fastener. The pole 8 can be made of any conventional strong and rigid material, such as aluminum or steel. For example, pole 8 can be made of a stiff T6061-T6 aluminum, and can be about 3 inches in diameter. Preferably, pole 8 is long enough to allow camera head 6 to be positioned 20 to 35 feet above ground, i.e., above the level of the street at the roadway or intersection being surveyed. The height of camera head 6 can preferably be adjusted depending on the type of vehicles that are expected to pass. Pole 8 preferably has means for mounting the camera head 6 securely thereon. At the same time, for easy storage, pole 8 is preferably capable of being contracted, although not necessarily so, to a shorter length. The entire device 2 is preferably small and lightweight enough so that several of them can be loaded into a small pick-up truck, station wagon, mini-van or SUV, and capable of being assembled and erected by one person in 30 minutes or less.

Because it is important for pole 8 to remain fixed, and not sway or move, even during high winds and rain, the present apparatus 2 preferably comprises a means of weighing down the support to help maintain and stabilize its position. This is preferably accomplished by multiple diagonal legs 18, 20, 22 as well as horizontal support arms, 26, 28, 30, wherein each support arm is attached to the bottom of the pole 8 and to near the lower end of one of the diagonal legs 18, 20, 22 and wherein each diagonal leg is attached to the pole 8 and to a heavy weight, such as a concrete block 32 weighing up to 80 pounds or more, that weighs the structure down. In the preferred embodiment, there are preferably three diagonal legs 18, 20, 22 and three arm supports 26, 28, 30, such as made of 1.5 inch diameter aluminum or steel tubing, arranged in a tripod configuration, and wherein the diagonal legs extend downward and outward from removable connectors located at an intermediate point on pole 8, and each support arm extends outward horizontally such as from removable connectors located at the bottom of pole 8, to form a tripod-like structure, with each diagonal leg 18, 20, 22 bolted to an adjustable screw-jack 34 embedded in its own reinforced concrete block 32.

For large adjustments, the length of each diagonal leg 18, 20, 22 is preferably adjustable in increments, such as every 6 inches for a total of 24 inches, such as by using telescopically extended sections 24. For finer adjustments, the level of each diagonal leg 18, 20, 22 relative to its concrete block 32 can preferably be adjusted by virtue of the screw jack 34 extending between each block 32 and the diagonal leg. By adjusting the screw jack 34 relative to each diagonal leg 18, 20, 22 and/or concrete block 32, the height of each diagonal leg 18, 20, 22 relative to each concrete block 32 can independently be adjusted. This way, by adjusting each telescopically extended section 24 and screw jack 34, the angle of pole 8 extending upward can be adjusted and maintained in a vertical position, regardless of the slope or condition of the ground. For example, even if the ground on which the apparatus 2 is situated is sloped, the pole 8 itself can be maintained substantially vertically, to help ensure the stability of the entire apparatus, and that an accurate view of the intersection can be obtained from the appropriate height.

This apparatus preferably enables the entire video recording system to be set up quickly and economically at virtually any location, regardless of whether there is an existing building or pole on which to mount the camera, and regardless of the size of the intersection, where large trucks and buses could pass on a regular basis. It also allows the support structure to be easily stored, carried and erected, thereby making it possible to transport the apparatus 2 to remote locations. This gives the traffic surveillance team more flexibility in setting up the video recording system in locations that are optimum for viewing accuracy and clarity, thereby helping to ensure better data. This also enables the system and method to be price-competitive.

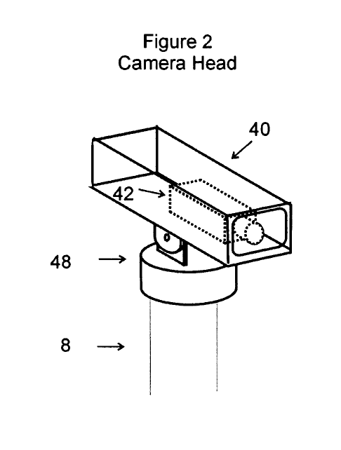

FIG. 2 shows an example of a video camera head 6 used to mount and aim a video camera either at the top of the support apparatus 2 or to an existing utility or other pole. The video camera head 6 consists of a weatherproof camera housing 40 that contains a video camera 42 mounted behind a clear window, and may also contain a heating device and fan (not shown). The video camera housing 40 may be attached to a pan-and-tilt device 48 that may be motorized or manually operated and that allows for the camera housing 40 and its camera 42 to be aimed horizontally and vertically. The pan and tilt device 48 may be securely mounted on top of the pole 8 shown in FIG. 1.

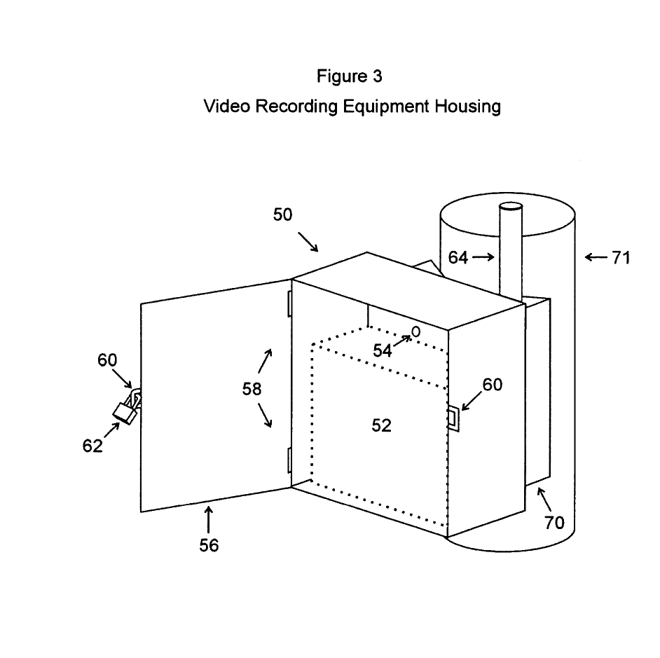

FIG. 3 shows an example of a weatherproof and tamperproof housing apparatus 50 used to house video recording equipment 52 (shown as dashed lines), such as a video recorder (either cassette recorder or DVR), and other components, that may include batteries, inverters, timer, quad splitter, time-date generator, control panel, heater and/or other devices. The housing 50 may be attached to a bracket 70 mounted on an existing pole 71, such as a street light or utility pole on which the video camera head 6 shown in FIG. 1 is also mounted, or to the pole 8 shown in FIG. 1, etc.

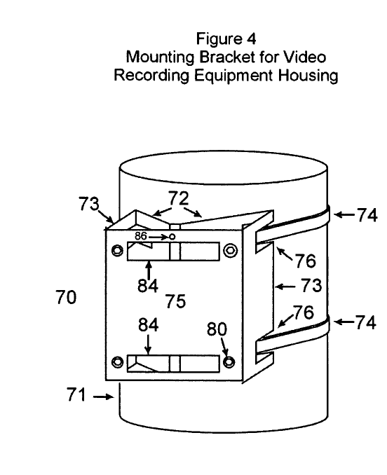

The housing 50 is preferably a strong weatherproof box-like structure made of tamper-resistant material, such as aluminum, steel or fiberglass, etc., with a tamper-resistant door 56 that has hinges 58 on one side to allow the door 56 to swing open and close. Preferably, the enclosure is designed to meet NEMA Type 3 specifications. A strong lock 62 capable of locking the door 56 to housing 50 to prevent unauthorized entry is preferably provided so that the contents of housing 50, which contains the video recorder and other equipment 52, can be maintained relatively secure from weather and vandalism. Housing 50 preferably contains mounting means (not shown) for mounting the recording equipment 52 securely thereto using cushioning material, such as plastic foam material, such that the equipment is insulated from any shocks that might occur if, for example, the housing was accidentally dropped. The housing 50 is made waterproof to prevent damage to equipment 52 in the event of rain or wind. A reinforced tube 64 used as a wiring conduit can be extended up from the equipment housing 50 or the mounting bracket 70 to the video camera head 6 as shown in FIG. 2. The rear wall of the equipment housing preferably has a hole for a security pin that may be a machine screw used to secure the equipment housing to the pole mounting bracket 70 shown in FIG. 4.

FIG. 4 shows a pole bracket 70 that is used to temporarily but securely attach the equipment housing 50 shown in FIG. 3 to an existing utility or other pole 71. The pole bracket 70 is preferably a hollow box-like structure made of a strong material such as steel or aluminum. The side that is placed against the pole 71 preferably consists of a folded bearing plate 72, with a V-shaped cross section, such that when bracket 70 is pressed onto pole 71, and held by means of two mounting bands 74, bracket 70 will be held securely to pole 71, and resist rotation with respect to the vertical axis of pole 71. The V-shaped cross-section of bearing plate 72 helps to assure that equipment bracket 70 can be attached securely to poles of different circumferences, i.e., for example in the range of 20 to 60 inches.

The mounting bracket 70 preferably has four openings 76 cut into the bearing plate 72 and bracket sides 73 to admit two mounting bands 74 that attach to machine screws 80 that pass through the front plate 75 of bracket 70. When the machine screws 80 are tightened, the bracket's bearing plates 72 are pressed against the pole 71, creating friction to hold the bracket securely in place. The machine screws 80 are preferably set into recessed openings on the front plate 75 of bracket 70, so that they do not project beyond the plate, thus allowing equipment housing 50 to be hung directly on front plate 75. The machine screws 80 are preferably attached to mounting bands 74 by means of a slip-on open socket nut hook (not shown), wherein the end of each machine screw 80, and the nut attached to the machine screw, can slide into the open side of the nut hook.

The mounting band 74 is preferably made of a strong band-like material, such as steel or aluminum, that can resist cutting or breaking. The front plate 75 of mounting bracket 70 preferably contains two openings 84 to receive the mounting hooks of equipment housing 50. The two mounting hooks preferably hang on the lower lip of the two openings 84 and hold the rear side of equipment housing 50 firmly against the front plate 75 of mounting bracket 70, such that machine screws 80 are completely covered and thus inaccessible. Once the equipment housing is hung on the mounting bracket, the mounting clamps cannot be loosened or removed.

A security pinhole 86 in the front plate 75 of mounting bracket 70 preferably receives the security pin 54 shown in FIG. 3. When the security pin 54 is placed through the hole in the rear of mounting bracket 70, and into the security pin hole of the mounting bracket, the equipment housing 50 cannot be moved in any direction with respect to mounting bracket 70, and thus equipment housing 50 cannot be removed from pole 71. The security pin 54 shown in FIG. 3 can only be removed by access to within equipment housing 50, so that when equipment housing door 56 is locked, there is no means of removing or loosening equipment housing 50 from pole 71. This way, it is more difficult for a vandal to steal or damage the recording equipment 52 inside housing 50, since he or she would have to break open the door 56 to remove the security pin 54. By making the housing 50 more difficult to break into and remove, the present apparatus 50 makes it possible for video recording equipment 52 to be maintained more securely, thereby reducing the potential for vandalism.

The method portion of the traffic surveillance invention relates generally to a system for monitoring traffic events at a predetermined location, using a temporary video camera set up to record traffic movements. In one aspect, the present invention preferably comprises a method wherein video recordings are recorded either on videotape or on a hard disk within a digital video recorder (DVR) or similar device at a predetermined location. The video equipment is preferably set up near an intersection or roadway, and securely positioned using one of the apparatuses discussed above, or any other similar device. The appropriate recording height as well as the orientation angle of the camera is preferably carefully determined to obtain the optimum view of the location. Appropriate protection for the camera and other equipment against adverse weather conditions and tampering, as discussed above, is preferably provided to protect the equipment, which can be costly. The video camera used to make the recording can be any conventional type, but preferably is able to record in analog or digital format and may include a time and date stamp capability. An onboard time-date generator provided either as a separate device or within the video recorder preferably displays the time and date of the recording onscreen, to avoid confusing the time and date of the count which occurs later. The onboard clock is preferably powered by a backup battery and accurate to a few seconds per year.

Prior to conducting onsite data acquisition, the site is preferably fully documented. This documentation preferably includes a schematic diagram labeled with GPS coordinates of the intersection, the name and compass bearing of each intersection approach, and digital photographs of each intersection approach. The diagram preferably includes the location and relevant attributes of all utility poles, and at least one and preferably two feasible sites for mounting the video recording equipments. One of these sites is preferably labeled as the recommended location, and includes the proposed approximate compass bearing of the camera's line of view and a ground-level digital photo of the camera's view from that site. In this respect, when the video operator installs the equipment, he or she preferably takes compass readings to verify the identity of the intersection approaches and camera viewpoint, and consults with the digital photos to confirm that the identity and direction of the approaches and camera location is correct. Further, bright cones or other markers visible to the camera are preferably placed on either side of the intersection approach closest to magnetic north. Also, the compass bearings are preferably compared to existing available scaled county maps. Later, a supervisor in the foreign country repeats this same confirmation process, using the site's documentation and the recorded video image, and available maps and intersection plans.

With the camera set up properly, the camera is preferably operated for a specific period of time, which can be hours, days or weeks, depending on the type of survey that is being conducted, although in most intersection turning movement counts, the survey is performed during several two or three-hour periods during a single day, as discussed above. The recording periods are set by the operator using the onboard timing feature of the video recorder. Once the camera is set up and turned on, an operator is able to leave the site and does not have to return until the survey is completed. This makes it possible for a recording to be made without having to maintain a human counter in the field, wherein a single technician can set up and operate simultaneous recordings of several different sites during a single day for increased efficiency.

Once the recording is completed, the tape is preferably brought back to a central office where the recording is, if necessary, converted to compressed digital format, stored as a file on a hard disk, and then copied onto an easy-to-use storage medium, such as a DVD. Digital video is well suited for this application because it enables the operator to step through data quickly, including jumping from one frame of the video to another, with frame-level accuracy. A tape recording does not provide this functionality.

The digital video file is then preferably shipped to a remote location, such as a foreign country, where the recordings can be transferred onto a computer or other server and reviewed using a specially designed data reduction application, to capture the attributes of the traffic events that occurred during the recording period. Although the recording of the video takes place on location in real time, technicians and operators in a foreign country, who can work at a reduced cost, relative to the country where the recording is made, preferably review the recording. The lower labor costs in the foreign country enable the counters to spend more time reviewing, counting and summarizing the information, and making sure the information and data are accurate. Because of the lower costs, there will be less pressure on counters to work faster, and there will be a greater likelihood that the counters will work more carefully and methodically, including slowing down, stopping, and/or re-reviewing the recordings as necessary, to make sure the count is correct. Additional counters, as will be discussed, can also be used, to create at least two database tables of observed traffic events, which can then be compared, reconciled and corrected by a third person for purposes of quality control. The lower labor rates also make the system more price-competitive, which may result in more reliable traffic studies to be conducted in the future.

The counters can play back the recordings to review the images on a computer system equipped with the appropriate software program. Whereas manual counts are conducted outdoors in potentially inhospitable weather, without access to restrooms, breaks or refreshment, the counting staff using the present method can work in a pleasant, indoor office and are preferably subject to continuous direct supervision. Counters have complete control over the speed of playback during event capture, can pause for breaks as required, and can easily back up and repeat difficult, confusing sections of the video. Whereas conventional manual counts are almost always conducted by temporary part-time workers, the controlled nature of the described traffic surveillance method allows for the counting to be carried out by full-time permanent workers who have received adequate training and a full range of non-salary benefits, leading to higher levels of motivation and accuracy.

The method preferably requires the use of a foreign office equipped with a computer system to review the video recordings. The service is preferably provided with the appropriate software program(s) that can be downloaded into the computer system, which will allow the recordings to be reviewed and recorded accurately in the manner to be discussed. The method also contemplates that the foreign counters and operators will have to be properly trained to help ensure that they will know how to make accurate and reliable indications and readings, including what to look for when reviewing the recordings. In this respect, it is important for the counters to know when a recordable traffic event has actually occurred.

A “recordable traffic event” is an event, such as a vehicle passing through the intersection, which must be counted for the traffic data to be accurate. The term is defined as a road user of a particular type performing a particular movement at a specific place and time. For example, a recordable event might be a Class 3 light truck executing a left turn from the southbound approach to the intersection of Roadway A with Roadway C, at precisely 8:06:03.23 a.m., on May 20, 2003. In this respect, it should be clear that if a recordable event is not counted, or if an event that did not occur is recorded, or incorrect information is associated with a recorded event, the data will be incorrect and potentially corrupted.

The present invention contemplates using a method that enables the counters to perform accurate and reliable readings and indications on a consistent basis, i.e., consistently know when an event is a “recordable event.” That is, for the data and any conclusions based on the data to be consistently accurate and reliable, the system requires the use of a standard definition to determine when a recordable event has actually occurred, so that when counters review the recordings in a remote location, they will know when to make the appropriate indication.

In this respect, scientific data is usually not considered credible unless it is replicable, i.e., an independent observer should be allowed to duplicate the results of an experiment. In the case of traffic data, whatever assertions are made about the quantitative characteristics of traffic flow should be verifiable by an independent observer. That is, for two or more observers of a recording to observe the same results, the described phenomenon should be replicable, using identical definitions of the phenomenon being observed.

Traditional methods for measuring and reporting traffic flow data do not permit independent observers to verify the data because it is observed in real time and cannot be repeated. While this shortcoming is overcome by using video to record and preserve the phenomena being observed, there have previously been no uniform definitions to determine how to measure the traffic attributes being observed. In this respect, traffic volumes are often described in terms of vehicles per fixed unit of time on a particular traffic channel, which could be a single lane, a set of lanes in the same direction, or a set of lanes in multiple directions. Accordingly, the definitional question is how does one define the exact moment in time that a recordable traffic event occurs? Depending on what definition is used, using past systems, a particular traffic event might be allocated to a varying time period, with the result that the summary statistics might not coincide.

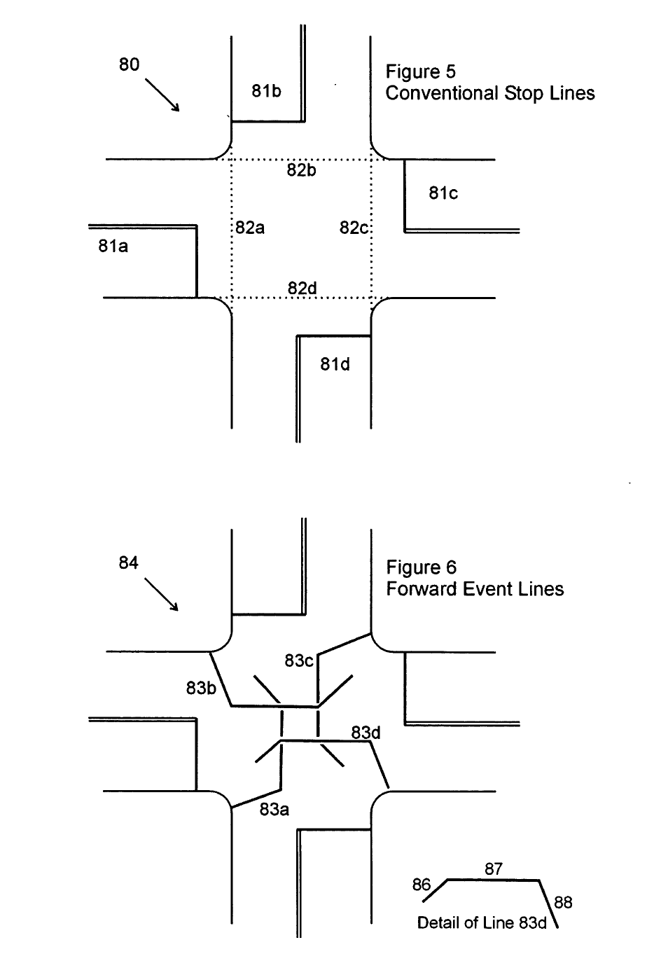

In this respect, if all vehicles proceeded continuously through an intersection, the issue of how to define the event would not be too complex. Conventionally, a vehicle would be counted when it “enters” an intersection. But the definition of “enter” actually varies widely. The problem is that most counted intersections are regulated by traffic control devices, including stop signs, traffic lights, etc., wherein traffic flow periodically slows to a low speed or stops, then resumes forward again when the lane is clear or when a traffic signal permits. FIG. 5 shows a conventional intersection 80 with stop lines extending across each lane of traffic, including lanes 81a, 81b, 81c, 81d. The dotted lines 82a, 82b, 82c and 82d show the projected curb lines across which a vehicle might pass to be counted using prior counting methods.

To facilitate a more accurate review of the recordings in the remote location, the present invention preferably contemplates using “event lines” that serve as definitions that can be superimposed on the video monitor, either physically on the screen, such as by using tape, or digitally within a software program that allows the line to be shown superimposed on the video image shown on the monitor screen. An “event line” 83, as shown in FIG. 6, is a line extending across a lane of traffic in the predetermined direction of traffic in a specific location and orientation, either in physical or digital cyber space. The event line is located within an intersection such that substantially all vehicles that stop for any significant length of time will do so before crossing the line, and such that a vehicle crossing such a line will have made an irreversible commitment to proceed with a particular movement, i.e., a left turn, a right turn, or U-turn, etc. A vehicle is preferably considered to have crossed an event line when the most visible front tire first touches the line. If it is a pedestrian being counted, then it is when one of the pedestrian's feet first crosses the line.

FIG. 6, for example, shows the same four way intersection 80, but with four “event lines,” 83a, 83b, 83c, 83d, extending across the lanes of traffic. When a four-leg intersection is monitored, one event line is preferably provided in each direction of traffic, forming four different event lines, 83a, 83b, 83c, 83d, one across each lane of travel.

In this case, each event line preferably has three sections that are angled relative to each other. The left section 86 is angled left to indicate that a left turn has been made when a vehicle crosses that section. The right section 88 is angled right to indicate that a right turn has been made when that section is crossed. The middle section 87 is perpendicular to the direction of travel to indicate that a vehicle has passed straight through when that section is crossed. This way, the event lines can help provide a specific indication of when a particular type of movement occurs, i.e., among 12 different movements in a four-way intersection.

Each event line 83 is also preferably extended well into the intersection, i.e., away from the previous curb designation shown as 82 in FIG. 5, so that when a vehicle stops short, or turns around before actually going through, it will not inadvertently be counted. Vehicles that go all the way through the intersection, i.e., that cross the event line, will, on the other hand, be counted on a consistent basis. In this respect, the present invention contemplates that the event lines can be located as approximately shown in FIG. 6, but also within a certain range. That is, if a line is drawn too close to the entrance of the intersection, a higher percentage of vehicles might stop on or beyond the event line, creating extra work to examine these records. On the other hand, if the line is drawn too far into the intersection, the line may be spread apart too far, in which case it may be difficult for each vehicle to be counted because of the size of the area that must be viewed. The present invention contemplates that an optimum or close to optimum location and orientation for each event line can be determined, using the criteria of the two constraints discussed above.

What an event line 83 represents is a precise linear boundary in a predetermined location the crossing of which by a vehicle triggers a recordable traffic event. In this respect, the event lines 83 not only help denote the occurrence of an event, i.e., that it actually happened, but can also assist the counter in knowing the precise moment in time that the event occurred, i.e., the actual time the event occurred in real time, which is when the vehicle physically crosses the line. Therefore, event lines 83, according to the present invention, can be of great assistance. to the operator in accurately determining if and when a vehicle has actually passed through an intersection, sufficient to constitute a recordable traffic event, as defined above.

A vehicle must physically cross an event line, in the direction of traffic, for the recordable event to occur, and therefore, the counter will always know whether a recordable event has actually occurred. For example, when a vehicle enters the intersection, but does not cross the event line 83, no recordable event has occurred, and therefore, the counter will know not to count that event. This can happen, for example, when a vehicle stops short within the intersection. At the same time, whenever a vehicle crosses an event line, the counter is trained to record the event. Even if the vehicle stops again after crossing the line, the counter will know not to count that vehicle again, since it has already crossed the event line. The only time when this might lead to some confusion is if the vehicle backs up and re-crosses the event line, but in such case, the counter will likely know that the vehicle has backed up, since it would take the vehicle several seconds to do so. Based on using the event lines, the potential for subjectivity and human error is significantly reduced, and the guesswork that might otherwise be involved in determining what constitutes a recordable traffic event, as well as the need for supervision, is significantly eliminated.

The method also contemplates that the computer program will be equipped with means for storing the event lines that are superimposed on the screen, including their locations and shapes, in persistent memory so that if the data needs to be reviewed afterwards, it can be checked in reference to the same event lines used originally. This can be done, for example, by creating the event lines interactively on an overlay that sits above the video image, wherein the coordinates of this information can be stored in a file that can be reloaded every time the video is shown. This way, a comparison can be made between similar data, i.e., a consistent definition can be applied to determine what constitutes a recordable event. The system preferably gives the option of making the definition permanent once it is made for any particular application, wherein the program can be made so that the definition cannot be altered except by a supervisor assigned with specific permission to do so, and never by an end user.

The system preferably uses a computer-operated program adapted to assist the operator in reviewing, verifying and summarizing the recorded information. In addition to a computer that enables the recording to be reviewed quickly, the present invention contemplates using a program that provides a way for the counter to indicate the type of recordable event that has occurred, at the time the event is being indicated (when the vehicle crosses an event line). For example, the program preferably has means to allow the operator to press a sequence of keys on the keyboard, which corresponds to the type of event that has occurred, so that while reviewing the images, the counter can press the appropriate key or keys, and, based on what event he or she has observed, indicate what type of recordable event it was. For example, the counter can press one key for a left turn, another key for a right turn, another for a vehicle passing straight through, another to indicate a U-turn, another to indicate a parking maneuver, etc., and this can be done for each lane or direction of traffic at the intersection, so that the direction of travel of each vehicle as it crosses an event line is also recorded. Preferably, the counter can also press an additional key to indicate the type of vehicle that passed through, such as a sedan, truck, van, bus, etc., as well as whether a pedestrian walked through, or a bus stopped to unload passengers, etc., so that the type of event is simultaneously recorded in the database.

The counter preferably presses a different key or sequence of keys for each type of recordable event, so that the type of event is simultaneously recorded as a single record in a table of events in a relational database such as MS Access. This allows the computer to keep track of each recorded event, at the same time the counter makes the indication in real time, so that the type of event that has been recorded is counted and stored for easy retrieval. The system is also designed to allow the exact time of the recordable event to be recorded simultaneously, at the same time that the other indications are made by the counter, which is accomplished by a synchronization feature, as will be discussed.

The program also preferably instructs the computer system to provide a signal indicating what type of event has been indicated. For example, as the counter steps through the video, and indicates when a recordable event has occurred by pressing the appropriate key or keys, a predetermined signal corresponding to the type of event that has been selected, such as a particular sound or light, can be emitted. Different colored lights or dots, for example, located on or adjacent the event line that has been crossed, associated with each type of movement or event that is indicated, can be displayed on the monitor if desired. Likewise, different tones, sounds or beeps generated by the computer, as each indication is being made, can be used for this purpose.

These signals help the counter know what type of indication it was, and therefore, enables the counter to instantly recognize whether the correct indication was made for any particular recordable event. That is, by virtue of the type of signal, or “announcement,” the counter will receive instant acknowledgement that the correct indication was made, or that the wrong indication was made. This way, the counter will instantly know whether he or she will need to immediately correct the indication, such as by replaying the recording and making the correct indication using the correct key or keys. The counter can see or hear the different signals, so that he or she can know whether the correct indication was made, and then be in a position to correct the indication before continuing.

In some cases, it is important to be able to identify the exact video frame number on which the recordable event occurred, that corresponds to an exact moment in real time, i.e., when the event actually occurred. Because digital video is presented as a series of discrete “frames” or images that are presented at a nearly constant rate, it is possible to use the frame number to determine the exact moment a particular event occurred, accurate to the reciprocal of the frame rate. In the preferred embodiment, the described invention records or converts the video into NTSC format, which plays video at an average rate of 29.97 frames/second, so that knowing the exact frame number that depicts a traffic event allows the program to calculate the actual time of occurrence to within approximately 1/30 second.

Because the counter, however, while reviewing the recording, presses keys typically days, if not weeks, after the recordings are actually made, there is always a difference between the screen time recorded on the recording, and when the counter actually counts them as recordable events (and effectively selects the frame number in the computer's memory). That is, although pressing a key determines what type of event has occurred, as discussed above, it will not, by itself (without some type of conversion), record the actual time of the event. For example, if a recording is made on December 12, between noon and 2:00 p.m., the payback of the recording (when the recordable events are being observed and selected) may occur days later, i.e., on December 19, between 9:45 a.m. and 5:15 p.m.

So, to know the actual time of a recordable event, each time a recordable event is observed and a key is pressed, a conversion will have to be made to convert that time to the actual time the event was recorded on tape. This would not be so problematic if the frame rate, i.e., the number of frames per second, always remained constant. Although a typical NTSC video has a nominal frame-rate of 29.97 frames per second, this rate does not typically stay constant throughout an entire recording. That is, in actual practice, the frame rate can differ from one section of the recording to another, so that over time, the cumulative frame number will not be an accurate guide to the actual screen time.

Accordingly, the present invention contemplates using a synchronization feature to make it possible to convert an exact frame number to a corresponding exact moment in time, and vice versa. In this respect, a calibration step is necessary to associate the recordable event with the actual time, which is accomplished as follows: While reviewing the recording, the operator occasionally enters the exact time shown on the video recording, i.e., at pre-selected time intervals (such as every 5 minutes of recorded time on the video), as a record in a calibration table of the survey site's database, so that this clock time is associated with the exact frame number when that time is displayed. This is done using the following calibration procedure:

The video is first divided into intervals of exactly nInterval seconds, which can be any arbitrary length, as long as it is exact. In practice, a good nInterval value that can be used is 600 seconds, which corresponds to 10 minutes, although virtually any amount can be used.

Next, an array is computed which is designated as nTotalSeconds[i], where i=0 to (nNumberOfIntervals=nTotalLength/nInterval). In this case, nTotalSeconds[0] is equal to the starting time of the counting period, measured as the number of elapsed seconds that have passed since the preceding midnight, i.e., based on the hours, minutes and seconds that have passed. For example, if the recording starts at 6:30 a.m. in the morning, the total hours elapsed will be 6.0 hours, and the total minutes elapsed will be 30.00 after the 6.0 hours. To convert this into seconds, therefore, the number of hours is multiplied by 3600 (seconds per hour), and the number of minutes is multiplied by 60 (seconds per minute), and any additional seconds are then added. In this example, the total seconds elapsed since the preceding midnight will be 23,400 seconds, which is based on the following calculation: (3600×6)+(60×30).

At the same time, nTotalSeconds[i]=nTotalSeconds[i−1] plus nInterval. So, in the above example, if an interval of 10 minutes or 600 seconds is used, and the beginning of the counting period at nTotalSeconds[0]=23,400 seconds (the time elapsed since the preceding midnight until the beginning of the interval), then nTotalSeconds[i=1] will be 23,400+600=24,000 seconds (the time elapsed after the preceding midnight until the end of the first interval), nTotalSeconds[2] will be 24,000+600=24,600 seconds (the time elapsed after the preceding midnight until the end of the second interval), and so forth.

Next, the method contemplates creating and populating a parallel array referred to as nFrameNumber[i], where nFrameNumber[i] is the sequential number of the first frame that corresponds to the screen time that is equivalent to nTotalSeconds[i]. The “frame number” is measured from the beginning of the video clip. The number of any particular frame is assigned by the playback software, which in the preferred embodiment is Microsoft DirectX. For example, if the number of the frame showing when the video is positioned to the beginning of the counting period is 1109 (i.e. at nTotalSeconds[0]), then nFrameNumber[0]=1109. The value of the remaining members of array nFrameNumber[i] are determined by having the operator manually step through the video, stopping the playback at exactly the first moment the clock time displayed within the video image is equivalent to the number of seconds in the calculated value of each nTotalSeconds[i], that is every nInterval seconds, and assigning the value of the then-current frame number to nFrameNumber[i].

Next, the method involves creating and populating another parallel array containing the local playback rate, defined as the number of video frames per second of real time, referred to as dLocalRate[i], where dLocalRate[i]=(nFrameNumber[i]−nFrameNumber[I−1])/(nTotalSeconds[i]−nTotalSeconds[i−1]). Finally, in order to estimate the exact frame number that corresponds to an arbitrary dTargetTime, the program uses the following algorithm:

First, the program finds the array index nIndex where nTotalSeconds[nIndex] is the largest value of nTotalSeconds[i] that does not exceed dTargetTime. Then, the program calculates the value nExactFrame that corresponds to dTargetTime, where dIncrement=dTargetTime−nTotalSeconds[nIndex] seconds and nExactFrame=(dLocalRate[nIndex]×dIncrement)+nFrameNumber[nIndex].

Using the above procedure, the computer is able to estimate the exact frame number that corresponds to an exact moment in real time to within 1/30^{th} of a second, which is to a degree of precision equal to the reciprocal of the frame rate. This way, the system can be calibrated in connection with each frame number on the recording, so that every event recorded in the database can be described in terms of the frame number and/or the exact clock time of occurrence, and the database can be searched for a specific individual event with a very high degree of accuracy using either the frame number or the time of its occurrence.

In this respect, the system preferably uses the video frame number as the primary means to determine time of occurrence, so that when an observed recordable event is recorded, the current frame number of the video is recorded as a field in the recorded event's database table entry. That is, when a key is pressed (to record an event), the program reads the frame number from the video playback object, and then, using the calibration values discussed above, the frame number is converted to the equivalent video screen time, i.e., the time the event actually occurred, and then this is also added to the event's database table entry. This way, when an operator wants to re-review the recording, the system will know, by virtue of the conversion, the exact time the event actually occurred. This allows the frame number to be retrieved by knowing the actual event time, and the actual event time to be retrieved by knowing the frame number. Each recorded event can be retrieved using either the frame number or the exact time it occurred.

This synchronization feature is helpful for purposes of comparing two database tables recorded from the same video file. That is, one of the methods used in the present invention, in conjunction with the lower labor costs, is a process that involves double checking the results of data reduction, by using two or more separate counters working independently from each other, to observe the same video file and construct separate database tables based on the same recordable events. When two independent observations of the same recording are made, there is always the possibility that one set of observations may differ from the other, wherein it may be necessary for a third person, such as a supervisor, to compare them on a record-by-record basis, to see what mistakes may have been made, and correct them if possible. The theory is that if a mistake is made by one observer, it would be very unlikely that the other observer would duplicate the same error, even though the second observer might make different errors. For example if each observer makes an error in 1 out of each 100 events, the probability that they will both make the same error is only about 1:10,000. By knowing how the two sets of observations differ, a supervisor can more quickly determine which observations may be in error and review these to make corrections. This is why it is important to have the time basis of the observations synchronized exactly, with the actual real time and frame number of the recordable events, so that the same recordable events can be compared with one another by virtue of when they occurred.

Thus, after creating two independent database tables of recorded events, the program preferably provides methods to compare the tables, identify anomalies, and correct errors. For example, the screen displayed on the monitor as determined by the program preferably consists of 1) the traffic video, 2) another window listing the previously captured data records and record detail, and 3) a video recorder window displaying video controls and information about the current video time and frame number. This way, the video can be advanced by playing it back, either at normal speed, a user-selected higher speed, or a user-selected lower speed, or it can be advanced by stepping through at intervals of 1 to 1000 frames. The user can also step through the video one event at a time.

The database display is preferably always kept synchronized with the video, so that as the user moves forward or backward through the video, the most recent traffic event is always highlighted in the database window. Further, at the exact moment an event occurs, it is, as discussed above, announced by a signal, such as a flashing colored dot on the screen at the location of the event, and/or by the sounding of a beep or tone. The color and location of the flashing dot preferably correspond to the location and type of event, and there are different beep tones for each type of event movement. If an error is detected, therefore, the user can simply double click on the record listing, which is then displayed in the record detail window for correction. The announcement feature discussed above is important to facilitating rapid and accurate verification that all the vehicle movements have been recorded correctly, and that there are no extraneous records in the database. The announcement feature facilitates identification of errors, which are amenable to ex-post editing and are easily identified and corrected.

Preferably, two individual counters independently process each video file. The product of their work is two separate database tables. Ideally, the two tables should be identical. It is inevitable, however, that there will be minor variations in the recorded frame number for each event. A carefully done database table should have the time recorded be accurate to within ⅓ of a second (about 10 frames) from the actual time of occurrence. Using the database verification feature, the program compares the two database tables, matching the individual records using the 0-10 frame criteria, and creating a new database table that shows both matched and unmatched records. A quality control technician can step through the listing of unmatched records, which are potential errors, and review the video for each one to determine which are in need of correction and making the appropriate adjustments. The result is a final database that should have a very high degree of accuracy. The comparison of two independently created databases greatly reduces the chances for counter error.

Unlike manual surveys that suffer from notoriously poor quality, the reliability of the data provided by the present system and method is assured because of the quality control techniques discussed above. Further, the results are always verifiable, because of the existence of the video record. The ability to quickly and visually review selected portions of the video record provides the client with a means to understand apparent data anomalies; for example, an unexpectedly high left turn volume, or fewer than the expected volume of trucks. With traditional methods, these anomalies are question marks that could undermine the credibility of the overall study and its recommendations; with a video-based survey, they become indisputable facts.

Another advantage is the ability to actually examine traffic flows that appear anomalous as a way of understanding why a particular intersection works the way it does. Often, direct observation of traffic flow is as beneficial or more so than quantitative analysis in explaining shortcomings of geometric design, signal timing or other site-specific traffic flow problems.

These features enable the user to analyze the database and produce tables of summary statistics. The final steps involve developing a set of tables and figures based on the data relating to the individual recordable traffic events summarizing the traffic characteristics at the survey site. The tables and figures can be displayed onscreen or exported to files in several standard formats. And, once the data analysis is complete, the program preferably enables the user to create standardized figures based on the summary tables, including turning movement diagrams and several types of hourly flow profiles and pie charts. The figures can then be displayed onscreen, stored in graphic files using raster or vector information, or sent to a printer, etc.

When the data analysis and reporting are completed, the results of all the data processing steps are transmitted back to a central office in the U.S.A., either uploaded to a server or sent as email attachments. In the U.S.A. office, this information is preferably copied onto a DVD that also includes the program and the original digital video file. As a work product, the client preferably receives the DVD(s) plus the printouts of the summary tables and reports.

In addition to the improved quality of the basic data, the present method and system provides further value to customers by providing a depth of data not available from existing methods. Intersection turning movement counts typically produce summary tables and diagrams that show traffic flow measured as vehicles per hour, stratified by 15 minute periods beginning at 0, 15, 30 and 45 minutes after the hour, and by left, through, and right turns on each intersection approach. This information can be used to calculate the Peak Hour Factor, one of the required input parameters for the analysis of intersection capacity. The Highway Capacity Manual (HCM) and other popular analysis models require other attributes that are not produced by conventional counts, so analysts normally use default values. For the HCM, these include percentage of heavy vehicles, frequency of bus stops, parking maneuvers and pedestrian conflicts. For non-signalized intersections, information on gaps and gap acceptance are also required. With the present method, these parameters can be obtained from the videotape with only minor additional cost.

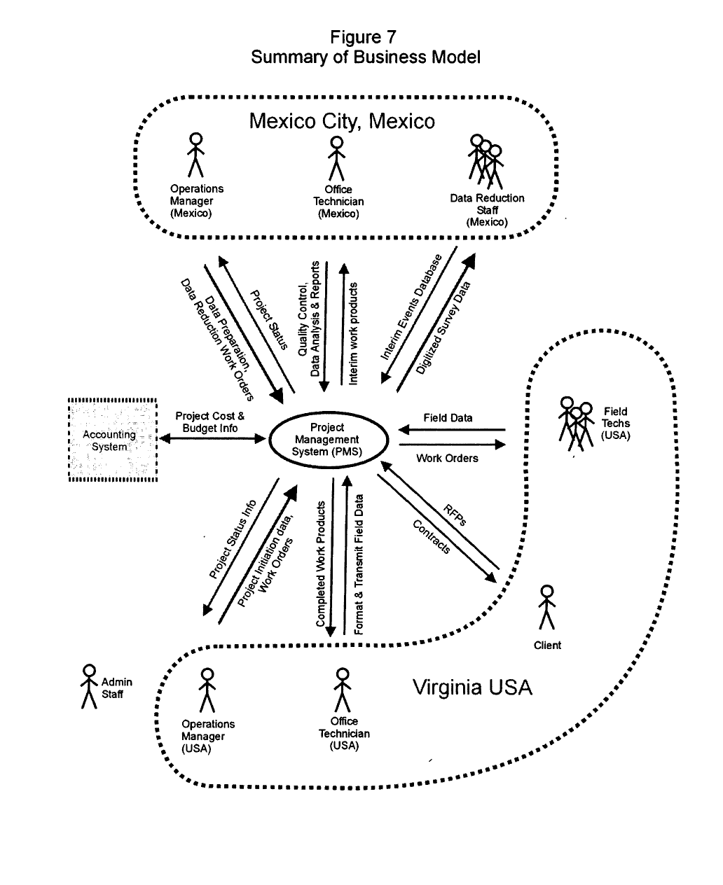

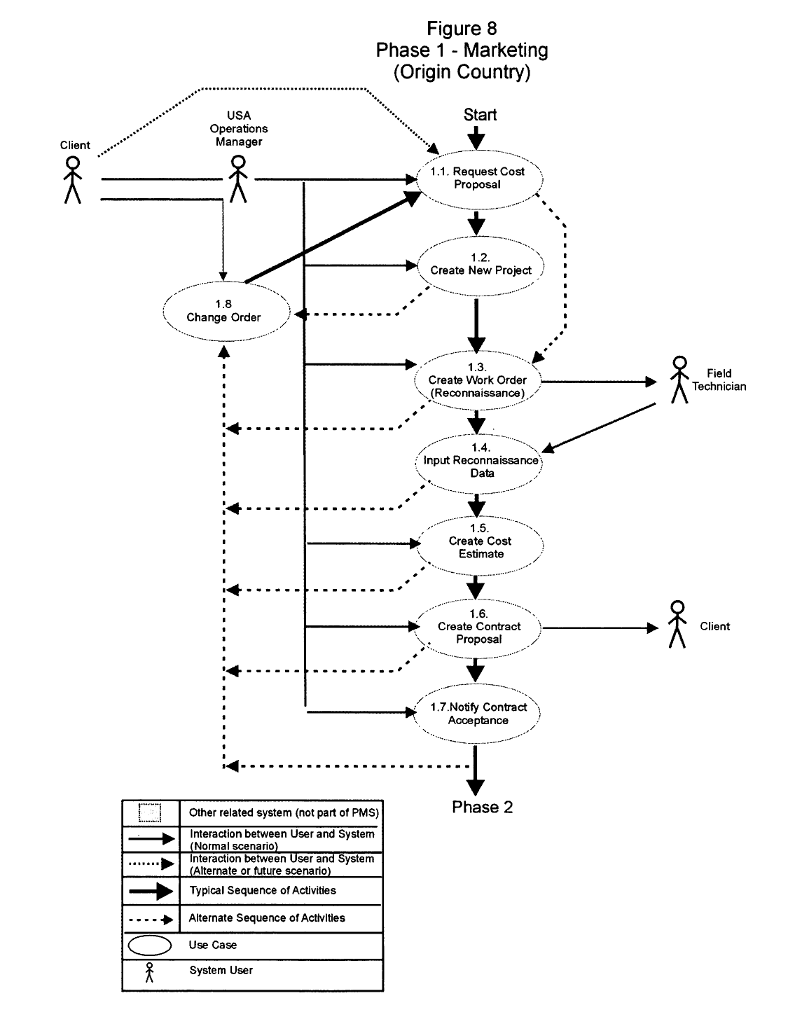

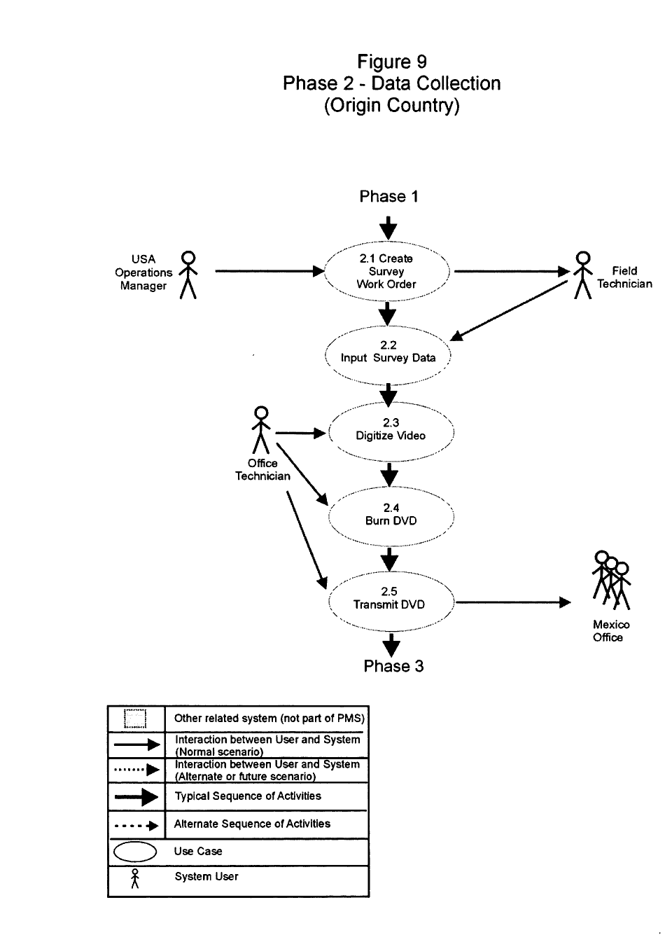

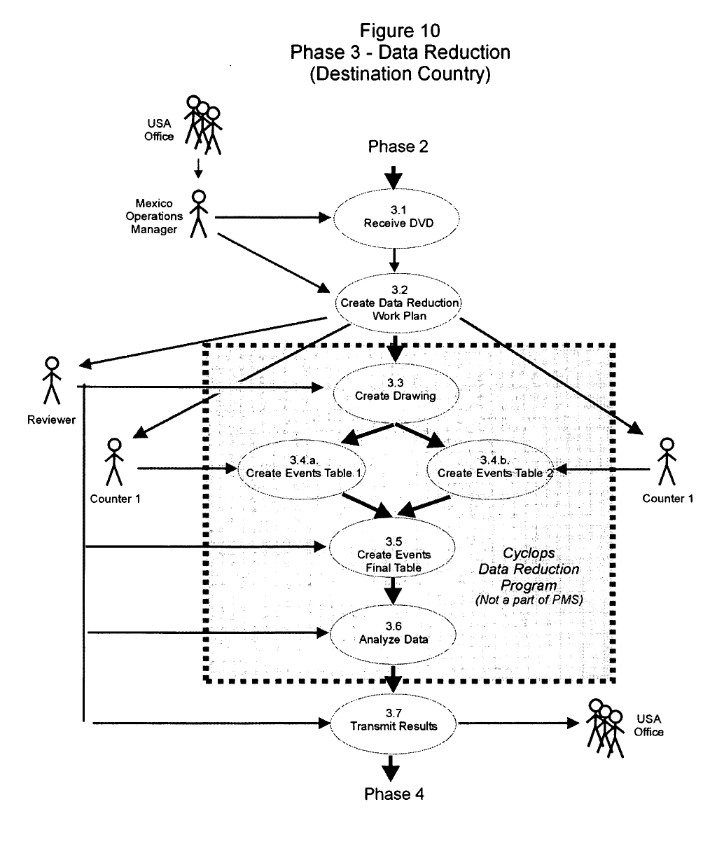

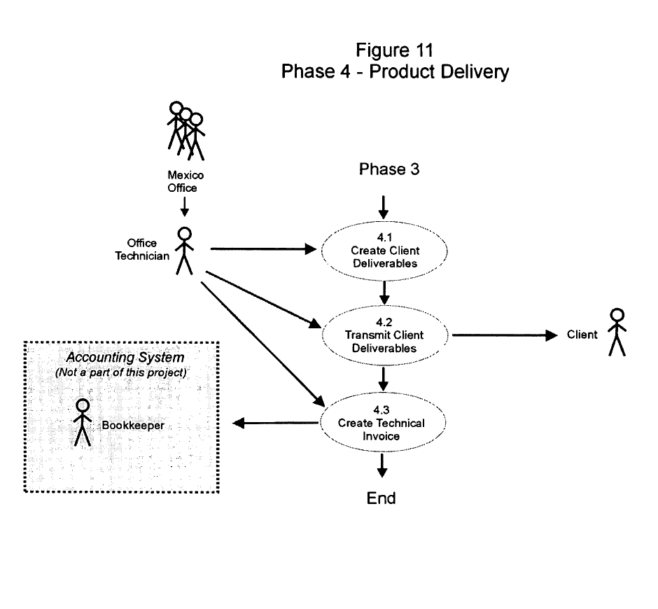

The preferred business model used to implement the above method, which is also schematically shown in FIGS. 7-11, is as follows:

In general, a client requests a set of traffic surveys. In such case, a client can be a developer, a city or other local government, etc. The traffic surveys are conducted in two phases. In phase one, data is collected in the origin country, which in the preferred embodiment is the U.S.A. (i.e., the data collection phase), and in phase 2 data is reduced in a foreign country (i.e., the data reduction phase). The results are sent from the foreign country back to the U.S.A., put into final form and transmitted to the client. Although the origin country will be referred to as the U.S.A., any origin country can be used.

The first phase involves marketing and planning. A client may contact the operations manager to request a price proposal to carry out a particular survey project consisting of one or more traffic surveys. The operations manager then preferably creates a request for proposal, i.e., an RFP, on the project management system (PMS), which is a computer program and relational database specifically designed to assist with the efficient implementation of the business model described herein. The RFP can be created in any manner, but can preferably be carried out online, by making the RFP form available to customers on a website, wherein the prospective client can fill out an RFP form on the website and transmit this electronically to the central office, and the operations manager or other person assigned to receive the RFP can process it.

Then, the operations manager preferably creates a new project in the PMS database, such as by creating new records describing the client, the locations where surveys are to be made, the timing of the surveys and the specific traffic events to be studied. He or she can then issue a work order for a field technician to carry out a reconnaissance of the survey site or sites. This includes, for example, visiting the site or sites to develop a work plan of how to carry out the surveys and the resources that would be required.

The field technician then preferably carries out the work order and enters the reconnaissance results into the PMS. This data preferably consists of written notes, a site sketch, and short videotape, all of which are added to the PMS as text, graphic or video files.

The operations manager then uses this data to develop a cost estimate for the project. The operations manager preferably creates a draft contract, which includes a summary of the cost estimate as an attachment, and sends this to the client for signature. The client signs the contract and sends it back, and a notation is made in the system that the signed contract was received.

The next phase involves data collection. The operations manager issues a work order for the surveys to be undertaken on a particular date, by a particular field survey staff. The field technicians then carry out the data collection, as described above, and deliver the results to the central office. This might consist, for example, of written notes, possibly a modified sketch, and the videotape, hard disk or other storage media, depending on the method of recording that is used. The handwritten material is preferably entered into the system.

The videotape is then digitized by an office technician using a capture program, wherein a computer file containing the digitized video is preferably created on a hard disk and copied to a stable storage media, which may be a DVD or other optical storage device. All of the data from the system relating to this project is then transmitted to the foreign country, either electronically over a wide area network such as the Internet, or by sending a DVD containing all the information by courier, for delivery the next day or the day thereafter.

The next phase is data reduction. The data is received in the foreign office and an entry is preferably made in the PMS acknowledging what was received. The files are then transferred to the system, such as by down loading them into the computer system or other server.

The technical supervisor in the foreign office then creates a work plan for the data reduction, and issues work orders to individuals, preferably including a reviewer'and two traffic counters, to carry out the data reduction phase. In this respect, the event capture process is preferably conducted using a specially developed proprietary software program which is separate from the PMS, although both programs preferably share a substantial portion of the same data.

The first data reduction task is for the assigned reviewer to create an overlay drawing of “event lines” for each video clip, as discussed above, which can be done physically on the monitor or digitally in the computer model and stored in a database. The files are then transmitted to the two counters. Each of the two counters then uses the above-described program's “event capture” methods to create a table of recordable traffic event records based on the digitized video clip. After both counters have finished the event tables, the reviewer than uses the “compare” methods provided by the program to identify and correct any errors, and produce a final events table. The reviewer then uses the program's “analysis” methods to produce several types of digital reports summarizing the data in the events table.

The complete results of data reduction, including the events tables and files containing the various summary reports are then sent, preferably by email or by uploading to an FTP site, to the central office in the origin country. Upon receiving this information, an office technician preferably creates the final deliverables, which preferably consist of one or more optical disks (either DVD or CD ROM, depending on what the client has requested) containing all the survey files, and hardcopies of the reports. The deliverables are then sent to the client, and a draft invoice is created and transmitted to the bookkeeper for further processing.

1. A method of conducting traffic surveillance studies, comprising:
recording video images at a predetermined location for a predetermined length of time;
converting the images on a medium for easier viewing of the images;
sending the medium to a foreign country where labor is less expensive than in the country where the images were taken;
providing a computer program for viewing the images in the foreign country;
providing at least one event line in association with the images to be displayed on a monitor to facilitate accurate viewing of the images, wherein an event line is adapted to be provided for each direction of vehicle traffic lane through the predetermined location;
reviewing the images on the medium; and
indicating when a vehicle crosses an event line that a recordable event has occurred.

2. The method of claim 1, wherein the predetermined location is an intersection, and wherein a recordable event occurs at the intersection whenever a vehicle crosses an event line in the direction of traffic associated with that event line.

3. The method of claim 1, wherein the predetermined length of time is between 1 and 24 hours.

4. The method of claim 1, wherein the medium onto which the recorded video image is originally stored is a videotape, hard disk, or optical storage media such as a DVD.

5. The method of claim 1, wherein recorded video images are converted to compressed digital format and stored as a file or files on a hard disk or on an optical storage device such as a CD ROM or DVD.

6. The method of claim 1, wherein the stored compressed video files are transmitted to the foreign country by express courier or by electronic data transmission over a public or private network.

7. The method of claim 2, wherein each of the event lines comprises a first portion for determining when a vehicle turns left, a second portion for determining when a vehicle goes straight, and a third portion for determining when a vehicle turns right, or multiple portions corresponding to each type of possible turning movement at a multi-leg or other complex intersection.

8. The method of claim 2, wherein the event lines are positioned within the intersection within the video image on the monitor screen in a manner that allows only vehicles that travel substantially through the intersection to cross the event line.

9. The method of claim 8, wherein the event lines are divided into several line segments arranged at different angles so as to maintain as much as possible the perpendicularity of each line segment relative to the direction of travel of the specific turning movement with which that segment is associated.

10. The method of claim 1, wherein the event lines are formed as lines superimposed on the video image window shown on the monitor screen, wherein the computer program enables the location of the event lines to be stored as a file on a hard disk or other persistent memory for future access and use.

11. The method of claim 1, wherein the program is provided so that whenever a recordable event is indicated, the computer provides a predetermined visual and/or audio signal to indicate when the recordable event has occurred.

12. The method of claim 1, wherein the program allows for different keys to be pressed depending on what type of recordable event has occurred in the predetermined location, wherein the type of recordable event that has occurred can be indicated by pressing a key or sequence of keys that corresponds to the type of road user (that is, a vehicle or pedestrian) and/or type of movement and/or the location of that movement within the intersection or road link being studied that resulted in the recordable event being indicated.

13. The method of claim 12, wherein the program is provided so that whenever a different key corresponding to a different road user, movement or event location is pressed, the computer provides a different predetermined audio or visual signal to indicate the type of event that has occurred.

14. The method of claim 1, wherein the images are recorded by a video camera mounted within a weatherproof housing, said housing being attached to a motorized or manual pan/tilt device that allows for the camera to be aimed horizontally and vertically.

15. The method of claim 14, wherein said pan-tilt device is mounted on a bracket attached to a pre-existing pole, or to a pole with a base having a predetermined number of legs, wherein each leg is connected to a concrete support, and wherein the level of each leg in relation to its concrete support can be adjusted by using an adjustable threaded member connected to the concrete support, and wherein that threaded adjustable member can be quickly moved upwards or downwards by using a hand-held power tool such as an electric drill equipped with a nut driver or screwdriver bit.

16. The method of claim 1, wherein the images are captured by a video camera are recorded by video cassette recorder or digital video recorder and related equipment located within a tamper-proof locked box, wherein the box is strapped to an existing pole by connectors that can only be released by having access to the interior of the locked box.

17. The method of claim 1, wherein the step of recording the images records the actual time during which the images are recorded, and wherein the program allows for the exact time that each recordable event is indicated to be synchronized with the actual time that the recordable event occurred, along with the video frame number on which the recordable event was recorded.
